(19) United States
(12) Patent Application Publication
(10) Pub. No.: US 2012/0259951 A1
(43) Pub. Date: Oct. 11, 2012

(54) Systems and Methods for Delivering Content to Vehicles

(76) Inventors: Thomas Barton Schalk, Plano, TX (US); Sammy Hallmi, Carrollton, TX (US); Scott Nelson, Dallas, TX (US); Frank Hirschenberger, Highland Village, TX (US); Karen Snow, Bloomfield Hills, MI (US); Leonel Saenz, Carrollton, TX (US); Barry Burch, Dallas, TX (US)

(21) Appl. No.: 13/524,856

(22) Filed: Jun. 15, 2012

Related U.S. Application Data
(63) Continuation-in-part of application No. 12/541,496, filed on Aug. 14, 2009.
Application No. 12/541,496 is a continuation-in-part of application No. 12/729,573, filed on Mar. 23, 2010.
Application No. 12/729,573 is a continuation-in-part of application No. 12/636,327, filed on Dec. 11, 2009.
(60) Provisional application No. 61/497,768, filed on Jun. 16, 2011.

(51) Int. Cl. H04W 8/00; G06F 15/16

(52) U.S. Cl. 709/217

(57) ABSTRACT

A content delivery system includes a remote data center in wireless communication with a vehicle telematics system. The remote data center includes a content server, an automated voice recognition system, and a database. The remote data center utilizes combinations of GPS information, voice automation technology, and preconfigured vehicle operator preferences to deliver content to vehicles over a wireless link. The content delivery system includes a web portal at which vehicle operators configure personal profiles, including information regarding personal preferences and/or information pertaining to application access. The web portal feeds the profile information to the remote data center over a remote Internet connection. The remote data center stores the preconfigured vehicle operator profiles in the database, which is later accessed in response to vehicle operator commands recognized by the voice recognition system.

### CROSS-REFERENCE TO RELATED APPLICATION

This application claims the priority, under 35 U.S.C. §119, of co-pending U.S. Provisional Application No. 61/497,768, filed on Jun. 16, 2011, the prior application is herewith incorporated by reference herein in its entirety.

This application is:
a continuation-in-part of U.S. patent application Ser. No. 12/541,496 [Atty. Docket: ATX/Criteria], filed on Aug. 14, 2009, which claims the benefit of U.S. Provisional Application No. 61/089,148, filed on Aug. 15, 2008;
a continuation-in-part of U.S. patent application Ser. No. 12/729,573 [Atty. Docket: ATX/Service Oriented], filed on Mar. 23, 2010, which claims the benefit of U.S. Provisional Application No. 61/288,067, filed on Mar. 24, 2009;
a continuation-in-part of U.S. Pat. No. 7,373,248 [Atty. Docket: ATX/Voice Delivered], which claims the benefit of U.S. Provisional Application No. 60/608,850, filed on Sep. 10, 2004;
a continuation-in-part of U.S. Pat. No. 7,634,357 [Atty. Docket: ATX/Voice Delivered DIV1], which is a divisional of U.S. Pat. No. 7,373,248;
a continuation-in-part of U.S. patent application Ser. No. 12/636,327, filed Dec. 11, 2009 [Atty. Docket: ATX/Voice Delivered DIV2], which is a divisional application of U.S. Pat. Nos. 7,373,248 and 7,634,357,
   the entire disclosures of which are hereby incorporated herein by reference in their entireties.

### FIELD OF THE INVENTION

The present invention pertains to systems and methods for delivering content to vehicles. More particularly, the present invention pertains to systems and methods for delivering specialized content based on user preferences stored in a database located at a remote data center and delivered through a wireless voice or data channel to the vehicle.

### BACKGROUND OF THE INVENTION

“Telematics,” as it is referred to in the art, includes the integration of wireless communications, vehicle monitoring systems and location devices. Such technologies in automotive communications combine wireless voice and data capability for management of information and safety applications. The advent of telematics services, which were introduced over a decade ago, brought with it a trend to incorporate the ability of a vehicle to communicate with remote data centers and transmit location data and vehicle information related to safety, security, and emergency breakdown.

Most of the early telematics communication was achieved through wireless voice channels that were analog in nature. By law in 2008, all analog connectivity became digital and, consequently, data connectivity, such as “3G” technology, became a readily available measure for mobile devices to “connect” to the Internet. As a result of these advances, the vehicle is also being adapted to leverage data connectivity in combination with voice channel connectivity in what is referred to as the “connected car” concept.

The “connected car” concept has continued to evolve over the past few years and commercial launches of rather sophisticated vehicle services are becoming a reality. These services often rely on vehicle location and on “cloud computing,” defined as web services accessed over a data channel. Examples of these services include off-board routing, destination capture, remote-vehicle diagnostics, music downloads, traffic reporting, local searches, access to concierge services, connecting to a vehicle dealer, and roadside assistance. The term “off-board” as used herein refers to a location away from and outside the vehicle. The term “local search” as used herein refers to a point-of-interest (POI) search based on proximity to a specific location. The examples given above are regarded as being vehicle-centric in nature and many invoke some form of vocal communication with a live agent or an off-board interactive automation system.

Recently, a trend has emerged whereby motorists operate personal devices while in a vehicle, such as mobile devices, in a way that makes it unsafe while driving. Built-in user interfaces are now being added to the inside of vehicles to provide these mobile functionalities as a component of the vehicle itself. However, a number of concerns about the safety and practicality of these built-in components still exist. It is difficult to enable personal device functionality in a vehicle in a way that makes it safe while driving. The user interfaces are not at all practical for a vehicle driver to use while driving. Not only are the screens of the devices rather small, but, more significantly, the primary input modalities to operate and use a typical mobile device include some form of typing or mechanical interaction by the user with the device. Driver distraction can occur when a driver's cognitive processing is allocated to any task that is not focused on driving a vehicle safely. Therefore, there is a need in the art for methods for providing information to and from a vehicle without undue distraction of a driver of the vehicle.

### SUMMARY OF THE INVENTION

An automatic voice recognition system located at a remote data center recognizes spoken target destinations while simultaneously utilizing GPS information transmitted from the vehicle over a wireless link to the remote data center. A voice user interface is designed to minimize vehicle operator interaction time and/or data center operator interaction time. Target destinations are determined with high reliability and efficiency by utilizing the combination of GPS information, voice automation technology, and preconfigured vehicle operator preferences. Content delivered to the vehicle (whether it be POI target destinations, music, news, traffic and weather reports, social media, or any other type of content one of ordinary skill in the art would contemplate delivering to a vehicle from a remote data center) is filtered based on preferences predefined by the vehicle operator in a profile created at an off-board web-portal.

Systems and methods for delivering content to a vehicle from a remote data center capable of determining access to and filtering content based on preconfigured personal profiles are disclosed. The inventive systems and methods implement a remote data center with an automatic voice recognition system, content server, and an off-board database of vehicle operator profile information, e.g. user profile information, which has been preconfigured at a web portal, for the delivery of requested content over a wireless link to the vehicle operator in a hands-free environment. Accordingly, speech commands are processed at the back end, i.e., at the remote data center, and the content that is delivered to the vehicle is customized. The customized content is based on the vehicle operator's personal preferences and access to various applications.

The primary advantages of the remote data center are flexibility, cost effectiveness, and personalization. Because the platform is off-board, the application and message content can easily be modified without changing any in-vehicle hardware, or software. In terms of cost, server-based voice recognition resources can be shared across a large spectrum of different vehicles. For example, each channel of the server-based voice-automation system can accommodate several vehicles simultaneously.

Locating the automated voice system at the remote data center provides substantial advantages over an embedded system inside the vehicle. The advantages include:
Increased operational flexibility and control from the call center;
Increased efficiency, because content can be added or modified with centralized hardware and/or software;
Improved scalability, because computer resources are shared across a large number of vehicles;
Improved usability, to the extent that calls from the vehicles can be monitored and improvements made at the centralized location, rather than in the vehicles;
Locating a “thin” client in the vehicle using standard telematics control units, rather than a specialized on-board computer; and
The ability to connect a vehicle driver to a human agent who is able to activate a new service specific to the vehicle.

Because of the off-board implementation, content can be filtered based on personal preferences predefined in a vehicle operator profile preconfigured at an off-board web portal.

Although embodiments illustrated and described herein are expressed as systems and methods for delivering content to vehicles from a remote data center over a wireless link, they are, nevertheless, not intended to be limited to the details shown because various modifications and structural changes may be made therein without departing from the spirit of the present disclosure and within the scope and range of equivalents of the claims.

The construction and methods of operation, however, together with additional objects and advantages thereof, will be best understood from the following description of specific embodiments when read in connection with the accompanying drawings.

### BRIEF DESCRIPTION OF THE DRAWINGS

Advantages of embodiments of the present invention will be apparent from the following detailed description, which description should be considered in conjunction with the accompanying drawings in which:

FIG. 1 is a block diagram of an exemplary embodiment of a content delivery system;

FIG. 2 is a flow diagram illustrating a process in accordance with an exemplary embodiment;

FIG. 3 is a flow diagram illustrating a process in accordance with another exemplary embodiment;

FIG. 4 is a diagrammatic illustration depicting transfer of information in a content delivery system in accordance with one embodiment; and

FIG. 5 is a block diagram of an example architecture according to one embodiment.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. It is believed that the invention will be better understood from a consideration of the following description in conjunction with the drawing figures, in which like reference numerals are carried forward. The figures of the drawing are not drawn to scale.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

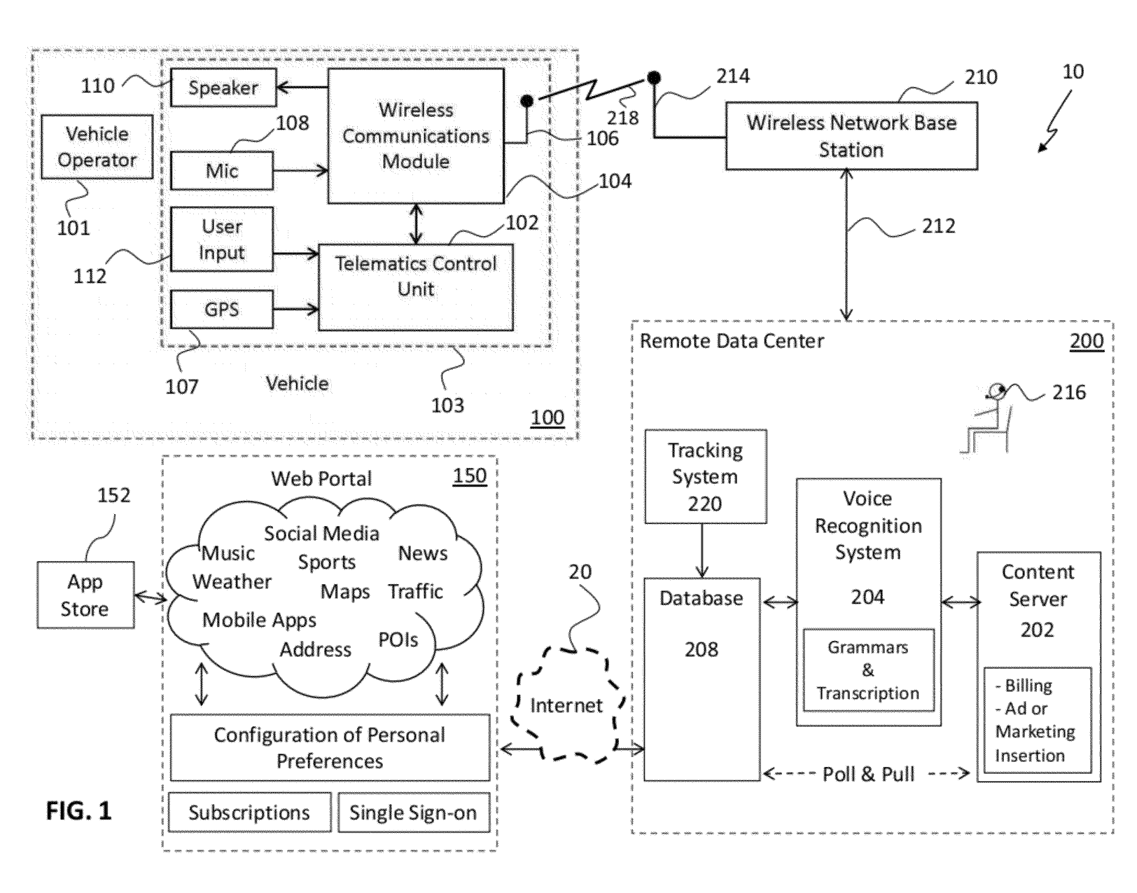

Described now are exemplary embodiments of the present invention. Referring now to the figures of the drawings in detail and first, particularly to FIG. 1, a block diagram of an exemplary system for delivering content to a vehicle according to one embodiment is shown. A vehicle 100, which includes any structure capable of movement, is operated by a vehicle operator 101. As used herein, the terms vehicle or vehicle operator are defined to be used interchangeably as the vehicle 100 may have many different individual vehicle operators 101, as such, when one is used herein, the other is included within that use if appropriate. The vehicle 100, according to one exemplary embodiment, is provided with a telematics system 103 that includes a telematics control unit 102, a wireless communication module 104, an antenna 106, a GPS receiver 107, a microphone 108, a speaker 110, and a user input 112, such as a button. A number of exemplary uses for a telematics system 103 are described in U.S. application Ser. No. 12/541,496, the disclosure of which has been incorporated herein by reference in its entirety.

As shown in FIG. 1, the content delivery system 10 includes a remote data center 200 in wireless communication with the vehicle's telematics system 103. The remote data center 200 is operable to receive communication signals from the vehicle 100 over a communication link 212 that is connected to a wireless network base station 210. The remote data center 200, according to one exemplary embodiment, includes a content server 202, an automated voice recognition system 204, and a database 208. The remote data center 200 communicates with vehicles through voice and data channels and is capable of managing a variety of vehicle-centric functionalities. The type of data communicated to and from the vehicle 100 includes, for instance, information related to vehicle location, diagnostic data, vehicle operator requests, and other vehicle-centric functionality. The remote data center 200 may also include one or more live agents 216 for communication with the vehicle 100 during extreme circumstances, e.g., in emergency situations or situations where the voice recognition system 204 is unable to recognize vehicle operator commands.

Exemplary embodiments describe throughout the present application that the voice recognition system 204 is located at the remote data center 200. However, in one embodiment, voice recognition system 204 may be implemented as part of the content delivery system 10 in a voice recognition system externally available in a speech recognition service cloud that may be accessed through the world-wide-web, similar to the voice recognition system disclosed in pending U.S. application Ser. No. 12/729,573, the entire contents of which has been incorporated herein by reference.

When a vehicle operator 101 initiates a telematics connection, the vehicle operator's spoken commands pass through the vehicle microphone 108, through the vehicle-mounted wireless communication module 104, through the vehicle mounted wireless antenna 106, over a wireless link 218, through the wireless network's antenna 214 and wireless network base station 210, through one of many available telecommunications networks 212 (wired and wireless), and into the remote data center 200. From the remote data center 200, the voice recognition system 204 interprets the spoken command(s). The command(s) may include, for example, a request for information regarding an address, a point of interest (POI), or a street intersection. Additionally, the command(s) may include a request for the delivery of content such as music, news, weather or traffic information, mobile applications, and social media to the vehicle 100.

The telematics request can be accomplished automatically or by pressing the button 112 and speaking a command that is detected by the microphone 108 within the vehicle 100. When a telematics connection is established between the vehicle 100 and the remote data center 200, information is exchanged between the vehicle 100 and the remote data center 200. This information can include vehicle location, vehicle model information, vehicle driver information, diagnostic information, and other information, all referred to as “statistics” herein. Some statistics may be known prior to the vehicle operator 101 pushing the button 112 and some statistics are captured at the time or after the button 112 is pushed. It is noted that pushing a button is only one exemplary way to cause the system to initiate a functional state. Other equivalent methods, such as speaking a particular command or touching a specific icon, may also be used.

In accordance with exemplary embodiments, the remote data center 200 is operable to receive information pertaining to preconfigured vehicle operator profiles from a web portal 150. Vehicle operators 101 are able to create customized profiles on the web portal 150 in advance of use and the web portal 150 feeds the information associated with the vehicle operator profile to the remote data center 200 over a remote Internet connection 20 anytime thereafter. If remote access of vehicle profiles is not always desired, the remote data center 200 can store the preconfigured vehicle operator profiles in the database 208 and access the vehicle operator profiles in response to vehicle operator commands recognized by the voice recognition system 204. Access to requested media, e.g., content, may be, for example, by way of subscription or through password entry, as defined in the vehicle operator's personal profile, which is dynamically updated at the web portal 150 and fed to and maintained in the database 208. The off-board automated voice system 204 and the other components shown in FIG. 1 provide significant advantages. The intelligence behind the presently inventive content delivery system is shared between the on-board and off-board components, but the majority of computing is performed at the remote data center 200, where more computing power is available than on the vehicle. Updates can be performed to the off-board components much easier than identifying and accessing the many mobile units utilizing the inventive system.

The vehicle operator 101 can access and modify his or her profile at the web portal 150 (and, thus, all applications and media content associated therewith) through a single sign-on either chosen by the vehicle operator 101 or assigned by the web portal 150. Personal preferences with respect to telematics content may be configured through web portal 150. In one embodiment, web portal 150 is operable to allow users to input their IDs and passwords associated with application and content providers as a part of their profile. The user can then access each of his or her linked applications through the web portal 150 with a single sign-on. Additionally, the vehicle operator's account may be linked with an identification number associated with the vehicle telematics system 103. Applications that provide telematics content may be purchased from, for example, an application store 152, through web portal 150. Example content provided by applications may include but are not limited to: music, weather, content provided by mobile applications, addresses, social media, sports, maps, news, traffic, and points of interest.

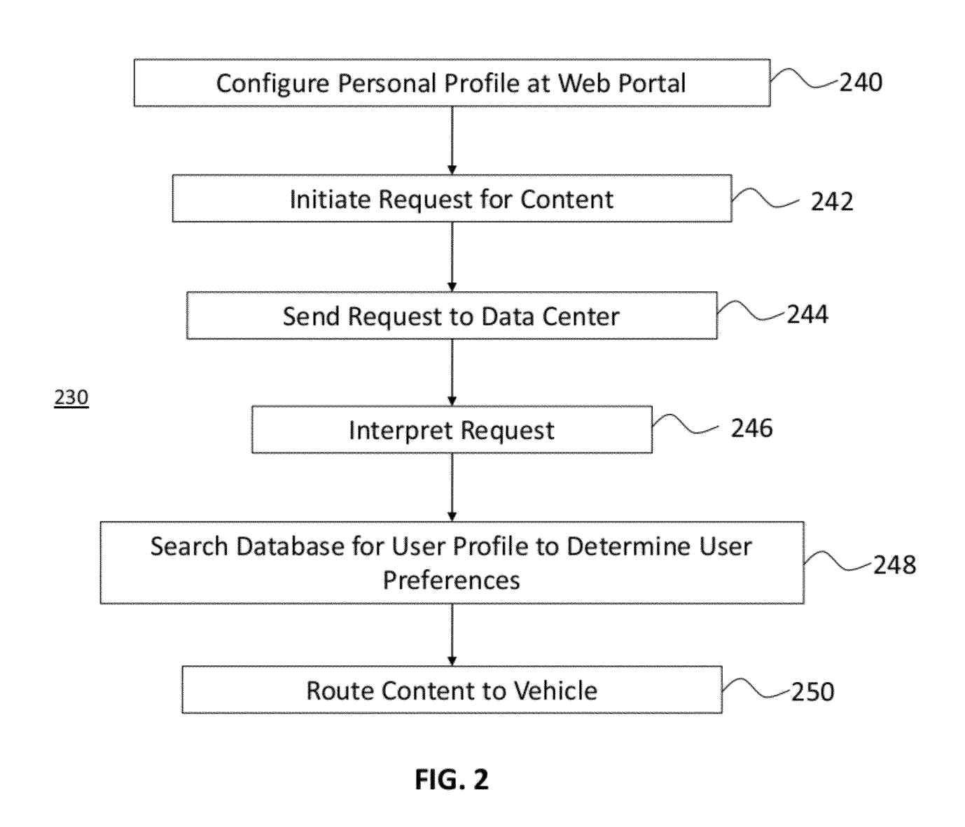

FIG. 2 illustrates an exemplary process 230, according to one embodiment. At step 240, the vehicle operator 101 configures his or her personal profile at the web portal 150. At some point in time after the vehicle operator 101 has created a personal profile and desires a telematics service, the vehicle operator 101 initiates a request for content at step 242. The telematics system 103 sends the request over the wireless link to the remote data center 200 at step 244. At step 246, the voice recognition system 204 interprets the request and the remote data center 200 searches the database 208 for the vehicle operator's profile to determine vehicle operator preferences at step 248. The vehicle operator's predefined preferences are, then, used in determining a result, e.g., result information, and the content is routed to the vehicle at step 250. The routed content comprises at least a portion of the result information.

In one embodiment, a vehicle operator 101 creates a profile on the web portal 150 that includes predefined personal preferences with respect to POI destinations. The web portal 150 may be configured with various drop-down menus for ease in the pre-selection of personal preferences. Personal preferences may include, for instance, information regarding restaurant and hotel ratings (e.g., I only like restaurants and hotels with at least a 4-star rating), restaurant cuisine or style (I like sushi; I do not like fast food), gas station preferences (I prefer TEXACO® gas; I want to find the lowest prices), and travel distance (I do not want to travel more than 10 miles for low gas prices). In response to a vehicle operator POI request, the remote data center 200 uses the predefined preferences to provide a more concentrated set of results with greater relevancy to the vehicle operator's command.

In this example, the vehicle operator 101 indicates intent, for example, through a specific button push, and speaks a command requesting information regarding a POI category (e.g., “I need to find a gas station nearby.”). The voice recognition system 204 attempts to recognize the spoken input. In an exemplary embodiment, the voice recognition system 204 is similar in configuration and function to the voice recognition systems disclosed in U.S. Pat. Nos. 7,373,248 and 7,634,357 and in pending U.S. patent application Ser. Nos. 12/636,327 and 12/729,573 (the disclosures of which have been incorporated herein), in which the voice recognition systems assign confidence scores to each recognition hypothesis. Once the vehicle recognition system 204 recognizes the POI category, the vehicle operator's predefined preferences are considered in determining the best result to deliver to the vehicle operator 101. Thus, the predefined preferences are used in ranking the probable results. The content delivery system 10 is further operable to distinguish whether digits are for an address or a business name so that search results are obtained and optimized and the delivery of ambiguous results is minimized.

For example, there are three gas stations within a 10-mile radius of the vehicle's location (provided by the vehicle's GPS 107): the first being a TEXACO® gas station selling gas at a first price and being located a first distance from the vehicle's present location; the second being another TEXACO® gas station selling gas at a second price lower than the first price and being located a second distance further than the first distance from the vehicle's present location; and the third being a SHELL® gas station located somewhere in between the two TEXACO® gas stations. Based on the predefined vehicle operator preferences stored in the database 208, the voice recognition system 204 automatically narrows the list to the two TEXACO® gas stations and assigns a higher confidence score to the second TEXACO® gas station because it has lower gas prices than the first and because it also is within 10 miles of the vehicle's present location. Thus, the preconfigured vehicle operator profile and database storage of the operator's predefined preferences serve as a short-cut to locating the most optimal result in response to a given command.

The remote data center 200 can automatically transmit the POI location information for the second TEXACO® gas station to the vehicle telematics system 103, which completes the destination entry on the user interface side because the GPS information for the vehicle position is all that is needed to determine the route to the determined POI. Alternatively, the voice recognition system 204 can first prompt the vehicle operator 101 for confirmation that the second TEXACO® gas station is the desired destination before sending the POI location information to the vehicle telematics system 103. Accordingly, the content delivery system 10 uses predefined vehicle operator preferences to narrow the possibility of results and deliver preferable results.

In another example, during the pre-selection of user preferences at the web portal 150, the vehicle operator 101 can assign a one-phrase command to a particular personal preference or set of preferences. The one-phrase command is preferably included within the grammars of the voice recognition system 204 so that it is easily recognized during voice applications. The one-phrase command can also be referred to as a POI even though it may be, in some instance, a broad characterization of a category of different singular points-of-interest. Once the voice recognition system 204 recognizes the one-phrase command, voice recognition system 204 automatically associates the one-phrase command with the appropriate customized preference(s) stored in the database 208 to return a more concentrated set of results with greater relevancy to the vehicle 100. Thus, the remote data center 200 can quickly determine the type of command the vehicle operator 101 has initiated and, based on the vehicle operator's profile of predefined preferences to which the one-phrase command is assigned, delivers preferable results.

For instance, a vehicle operator 101 assigns the word “gas” as a POI label for his or her personal preferences associated with gas stations: I like TEXACO® gas; I want to find the lowest prices; and I want to travel no more than 10 miles for low gas prices. In this example, the vehicle operator 101 initiates a telematics request, e.g., by pressing a button 112, and speaks “gas.” The voice recognition system 204 recognizes “gas” and associates “gas” with the vehicle operator's pre-assigned “gas” preferences to find and deliver information about the nearest TEXACO® gas station with the lowest prices and within a 10-mile radius.

In another example, the content delivery system 10 includes a tracking system at the remote data center 200 operable to keep track of a vehicle operator's past successful usage. This information is then reported to and stored in the database 208. From the vehicle operator's tracked usage, the remote data center 200 is able to learn and recognize the vehicle operator's preferences, which information can be used in ranking possible results. For instance, the vehicle operator 100 repeatedly follows routes delivered to the vehicle 100 from the remote data center 200 to TEXACO® gas stations. The tracking system tracks these repeated routes and a record of the tracked routes is stored in the database 208. The remote data center 200 recognizes the vehicle operator's preference for TEXACO® gas stations and chooses a TEXACO® gas station as a default when confronted with a gas station POI command that emanates from a similar origin as provided by the GPS. Thus, the content delivery system 10 is operable to track vehicle operator usage to determine vehicle operator preferences and use that information in the delivery of requested content to the vehicle 100.

In yet another example, the content delivery system 10 is operable to provide driver-initiated location marketing content. As an example, a vehicle operator 101 may include in his or her profile configured at the web portal 150 a list of stores (POIs) where he or she shops most often, i.e., preferred stores. The vehicle operator may associate the preferred stores with specific merchandise. These preferences, like those discussed above in previous examples, are transmitted to and stored in the off-board database 208 at the remote data center 200. Also similar to one of the exemplary embodiments described above, the vehicle operator 101 may assign a one-phrase to any of his or her preferences. For example, a vehicle operator assigns the word “shoes” as a broad POI to a preferred list of stores where he or she likes to shop for shoes. While driving, the vehicle operator 101 initiates a telematics request by pressing the button 112 and speaking “shoes.” He or she wants to find a nearby location for shoe shopping, and, optimally, he or she would prefer certain stores to others. He or she may also prefer to know about any ongoing promotions or available coupons at his or her favorite shoe stores. Once the voice recognition system 204 receives and recognizes the spoken command, the voice recognition system 204 determines a number of possible shoe store results based on vehicle location and the vehicle operator's shoe store preferences predefined in his or her profile.

Also in accordance with an exemplary embodiment, the content server 202 polls the database 208 for the vehicle operator's store preferences associated with the word “shoe” and gathers any relevant marketing information, e.g., coupons and promotion codes, and provides information about the marketing material to the vehicle 100. In some cases, the voice recognition system 204 provides an audio message to the vehicle 100 that references a special promotion occurring at a particular shoe store and provides directions and other information that will allow the vehicle operator to take advantage of the promotion immediately. In addition, the message may indicate that an email or text message with details will be sent to the vehicle operator 101. When a vehicle operator 101 configures his or her profile on the web portal 150, he or she may opt in to or out of receiving marketing content. The vehicle operator may also designate a preferred mode of delivery for this type of marketing information.

Third parties, e.g., retail stores, restaurants, hotels, and any other customer service provider, may provide marketing materials directly to the remote data center 200. Alternatively, the third parties may upload marketing materials to the web portal 150, and the remote data center 200 receives the marketing materials in the same way as preconfigured vehicle operator profiles are received. In response to a spoken command, the content server 202 cooperates with the voice recognition system 204 to poll the database 208 for relevant marketing materials, pull the relevant content, and deliver the relevant content to the vehicle 100.

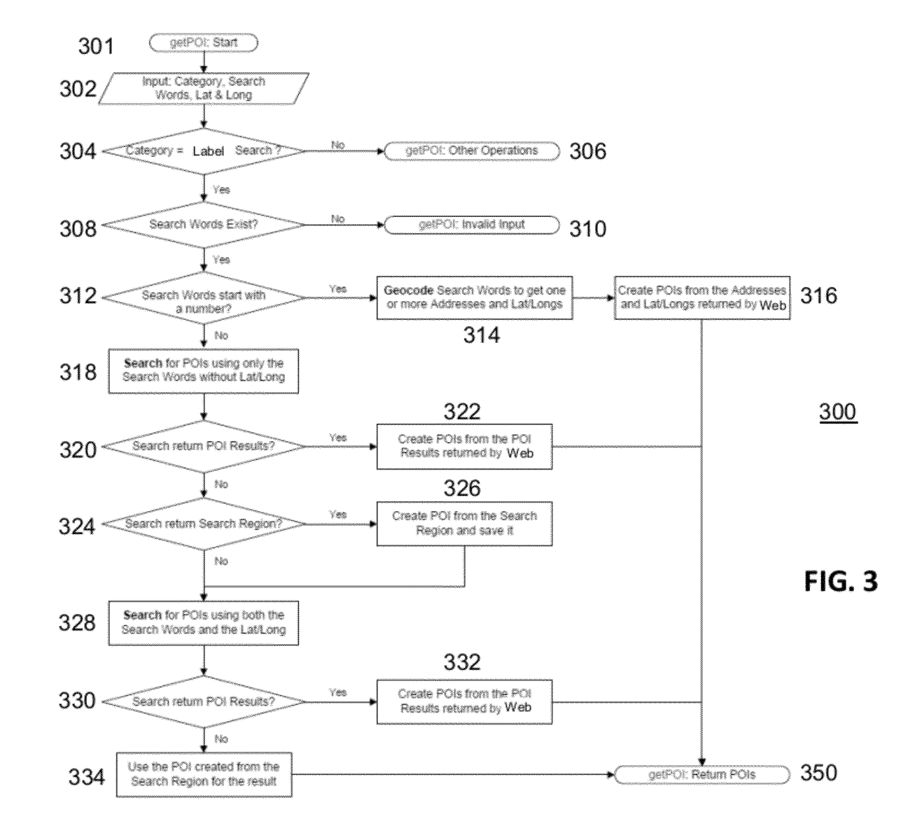

FIG. 3 is an exemplary flow diagram 300 of systems and processes for implementing the searches described above. The flow diagram begins at step 301. In step 302, the system, e.g., telematics unit 103, obtains the POI input from the user in any form. The POI can be, for example, a category, a label, a set of words, an address, or latitude/longitude coordinates. To process the request fastest, the system analyzes the POI input to determine, in step 304, if the input is within the list of possible search terms. If not, then in step 306, the POI input needs to be further processed, e.g., the user is prompted to re-enter or correct the input. If the POI input is recognized, then the system, in step 308, determines if the POI input falls within the list of predefined, quick-search labels, such as the label “gas” mentioned above. If not, then the system determines that invalid input has occurred, in step 310. If the input is one of these predefined labels, then, to quickly separate the labels, the system can ask, in step 312, if the input starts with a number. If the input starts with a number, then the system assumes, in step 314, that the input was either an address or a coordinate geo-location (e.g., latitude/longitude). POIs are created by the system in step 316 and provided to the user in step 350. POIs created in step 316 can be created from the addresses and latitudes/longitudes returned by the web service, e.g., the latitudes/longitudes produced in step 314.

If the input does not start with a number, then the system performs an efficient search by eliminating addresses and geo-locations, in step 318. If the search returns POI results in step 320, then the system creates the POIs in step 322 and provides them to the user in step 350. If, however, no POI results are returned, the system determines if the input can be used to obtain POIs from a search region, in step 324. If yes, in step, 326, the POI or POIs are saved and used, in step 328, in a POI search including words and phrases starting with numbers. If POIs are returned from this search, then the system creates the POIs in step 332 and provides them to the user in step 350. If no POIs are returned, then the POI created from the search region is used as the result, in step 334, that is provided to the user in step 350.

In yet a further exemplary embodiment, the content delivered to the vehicle 100 is in the form of media or other content that may be accessible through mobile device applications or Internet applications, herein after collectively referred to as “applications.” Applications may include, for example, content that can be downloaded, streamed, cached, or real-time transmitted to the vehicle 100 through the Internet or mobile devices. Existing automotive entertainment platforms must be tailored to technically support specific consumer mobile devices and specifically-written applications in order to bring the application-supported content into the vehicle 100. Thus, the applications and services are currently vertically integrated with in-vehicle systems and not all mobile devices and automotive electronic platforms are capable of supporting particular applications.

A multimedia services and content platform that does not require application customization by the vehicle manufacturer is provided. Content is delivered from the off-board database 208 at the remote data center 200 to the vehicle 100 over a wireless link. Because the delivery platform is largely off-board, an entire portfolio of applications can be maintained dynamically without having to update any in-vehicle hardware or software. Various applications are downloaded to, or their constituent contents maintained at, the database 208 at the remote data center 200, which serves as a master content aggregator of applications. The remote data center 200 remotely feeds media associated with the various applications to any number of vehicles 100, in which the vehicle operators 101 are able to access the applications using a vehicle application interface. Rather than using a linked mobile device, the vehicle application interface is used advantageously as a guide to switch between “channels” of various applications and media content.

Additionally, the content delivery system 10 eliminates the need for application providers to customize applications for particular automotive electronic platforms. The content delivery system 10 is not limited only to vehicles. The content delivery system 10 may be associated with a mobile device (e.g., a mobile phone) in addition to, or in place of the vehicle 100, for the delivery of applications (e.g., gaming or music applications) to the mobile device, which would eliminate the need for application providers to customize applications for particular mobile devices as well. Instead, the applications are commonly provided to the remote database 208 (and, thus, the vehicle or mobile device interface communicatively connected thereto) through the off-board web portal 150 and, therefore, need only be compatible with the web portal 150 and database 208 interfaces. Further, when an application provider develops an update for a particular application, instead of having to update the application on each individual mobile device or each automotive electronic platform, that application can easily be updated dynamically in real-time through the web portal 150 and/or database 208.

The web portal 150 and database 208 serve as a common interface for various applications. In addition to predefining preferences in a personal profile at the web portal 150, as in the exemplary embodiments described above, vehicle operators 101 can also configure their profiles with various applications. In an exemplary embodiment, the web portal 150 is operable to access a variety of the vehicle operator accounts with participating application providers through the vehicle operator's sharing of account information (i.e., username and password information) with the web portal 150. Accordingly, the vehicle operator 101 is able to link as many application accounts as desired with the web portal 150 (as long as the application provider is a participating application provider) and the vehicle operator 101 can access and modify these accounts through his or her profile configured at the web portal 150. In addition, once the link to an application account is created, the remote data center 200 can update the database 208 by directly accessing the application provider in the web portal 150. This, in turn, will cause updates to components within the remote data center 200, including, but not limited to, the voice recognition system 204.

During profile configuration, the vehicle operator 101 can also predefine preferences with respect to content associated with the various applications. For example, the vehicle operator 101 can list preferred news providers (e.g., that National Public Radio (NPR) is the operator's favorite news provider) so that the system 10 knows where to go first when confronted with a request for the delivery of news content.

Additionally, once a vehicle operator 101 has configured his or her profile, the content delivery system 10 is operable to create and store in the voice recognition system 204 certain customized grammars associated with the personal profile, very much like the grammars assigned and used in connection with the one-phrase commands in the exemplary embodiments described above. This way, the vehicle operator 101 can configure voice recognition grammars tailored to their personal profile stored in the database 208. If desired, functionality can be included to record the vehicle operator's voice corresponding to the grammar stored in the personal profile, making easier subsequent interactive voice recognition. The remote data center 200 can maintain, check, and adjust the grammars on a regular basis.

In any of the described exemplary embodiments, the vehicle operator 101 can access and modify his or her profile at the web portal 150 (and, thus, all applications and media content associated therewith) through a single sign-on either chosen by the vehicle operator 101 or assigned by the web portal 150. In this exemplary embodiment, the web portal 150 is operable to allow users to input their IDs and passwords associated with application and content providers (e.g., those associated with a user's PANDORA® or AMAZON® account) as a part of their profile. The user can then access each of his or her linked applications through the web portal 150 with a single sign-on. Additionally, the vehicle operator's account may be linked with an identification number associated with the vehicle telematics system 103.

As another example, the vehicle operator 101 wishes to play media (audio and/or video) through an application or content provider, e.g., PANDORA®, SLACKER®, RHAPSODY®, MOG™, RDIO®, GRACENOTE®, STITCHER®, etc. The vehicle operator 101 initiates a request for media, e.g., by pressing the button 112 and speaking a command, such as “Internet radio.” The request is sent over the wireless communications link 218, through the wireless network base station 210, over the telecommunications link 212 to the remote data center 200 and the voice recognition system 204 interprets the request.

In this exemplary embodiment, the remote data center 200 polls the database 208 to determine whether the vehicle operator 101 has access to the media requested. Access to the requested media may be, for example, by way of subscription or through password entry, as defined in the vehicle operator's personal profile, which is dynamically updated at the web portal 150 and fed to and maintained in the database 208. The remote data center 200 verifies that the vehicle operator 101 has access to receive media from the specific application with which the requested content is associated. If the vehicle operator 101 does not have access to the requested content, the command is terminated and the vehicle operator 101 may be prompted to: (a) make a new request; (b) enroll/subscribe to a new application service to obtain access; or (c) make a one-time purchase for the requested content. Options (b) and (c) can be executed as part of a billing system present at the remote data center 200. If the vehicle operator 101 does have access to the requested content, the content server 202 pulls the media and the remote data center 200 delivers the media to the vehicle 100. Audio media is played through the vehicle's audio system and video media may be played on the vehicle's display screen.

In a more specific example, the vehicle operator 101 makes a voice command requesting that application X (e.g., PANDORA®) play media Y (e.g., a music station for artist “A”). The vehicle operator 101 speaks the command into the hands-free microphone 108 located in proximity to the vehicle operator 101. The vehicle operator's spoken command(s) passes through the vehicle's wireless communication module 104, the vehicle's wireless antenna 106, through the wireless link 218 to the wireless network's antenna 214 and wireless network base station 210, through one of many telecommunications networks 212 (wired and/or wireless), and into the remote data center 200. At the data center 200, the voice recognition system 204 interprets the spoken command as the request for use of the PANDORA® application. The content server 202 searches the database 208 to verify that the vehicle operator 101 has access to the PANDORA® application. Assuming that the vehicle operator 101 has access to PANDORA®, the content server 202 pulls the requested content for continuous delivery of A's music station to the vehicle 100 until commanded otherwise. Accordingly, the content delivery system 10 (i.e., the connection between the web portal 150, the remote data center 200, and the vehicle 100) allows seamless streaming of audible media to the vehicle 100 at the verbal request of the operator 101.

As an alternative embodiment, in a situation where the application provider does not allow their content to be delivered through an intermediate content server 202, the requested content may be delivered directly to the vehicle 100 once selection has been successful. Once the selected content at the content provider has been identified through an application programming interface (API) interaction, the content provider directly sends a specific URL/URI (uniform resource locator or uniform resource identifier) for that content to the on-device application. The on-device application then directly gets the stream from the content provider site using the URL/URI.

In one embodiment, there are specific user-created names/station names/playlists at the various internet content providers. In order to properly recognize and request these custom user-created names, a voice recognition system can directly access a content information site for information related to a particular user and to cross-examine the user-created names with the detected utterance, e.g., through transcription text string matching or grammar-based categorization, to properly recognize and send the appropriate specific content request to the provider.

In another exemplary embodiment, the remote data center 200 is operable to deliver advertisements or other messages to the vehicle interface in conjunction with the requested content. Examples of such delivery methods are described in U.S. patent application Ser. No. 12/541,496. Advertising companies may cooperate with any of the application providers to implement their ads with a particular application. Alternatively, the remote data center 200 could include its own ad insertion platform compatible with the content server 202, wherein the remote data center 200 interrupts delivery of the requested content to deliver advertisements, amber alerts, media, etc. to the vehicle operator 101. Such advertising could be a source of revenue for owners of the remote data center 200. In another example, the ad insertion platform could provide a channel manager interface in order to manage the type of content played to users on a certain channel (i.e., accessing a certain application).

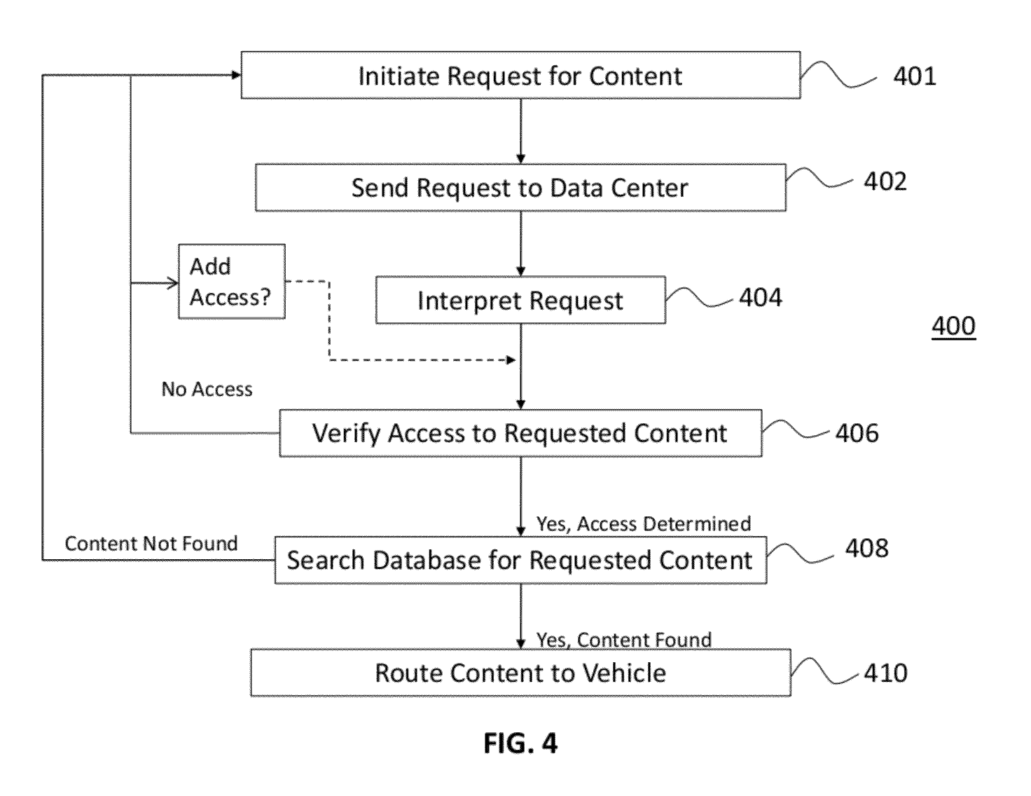

Referring to FIG. 4, an exemplary process 400 includes initiating a request for content at step 401. The request is sent to the remote data center 200 at step 402. At step 404, the voice recognition system 204 interprets the request and, at step 406, the remote data center 200 then verifies access to the requested content. If access is not found, then the process starts over again or the user is prompted with an option to add access (e.g., through a new subscription or purchase of content). If access is determined, then the database is searched for the requested content at step 408. If the content is found, the content is routed to the vehicle 100 at step 410. However, if the content is not found, the process starts over again.

Advantageously, the inventive systems and methods eliminate the need to customize automotive electronics platforms to support specific applications. In this way, a vehicle operator 101 is provided with a personal profile capable of integrating various applications, which may be bundled in packages or included free of charge (i.e., included with the vehicle price or for a predefined time period). In one exemplary embodiment, vehicle operators 101 are allowed to enroll in new services/add new applications through the web portal 150. Vehicle operators 101 no longer need to worry about personally downloading and/or upgrading applications or vehicle software or hardware associated therewith and car companies no longer have to rewrite various applications for the customization of particular automotive electronics platform compatibility or for the implementation of new updates. The remote data center 200 takes over and serves as a master content provider by downloading, streaming, and caching as many applications as desired, performing all necessary upgrades, and providing the content associated with these applications to vehicles over a wireless connection, using a common interface capable of supporting the different applications. Thus, the content delivery system 10 removes the requirement for the vehicle operator 101 to interact with multiple content suppliers because the remote date center 200 services as an aggregate content provider.

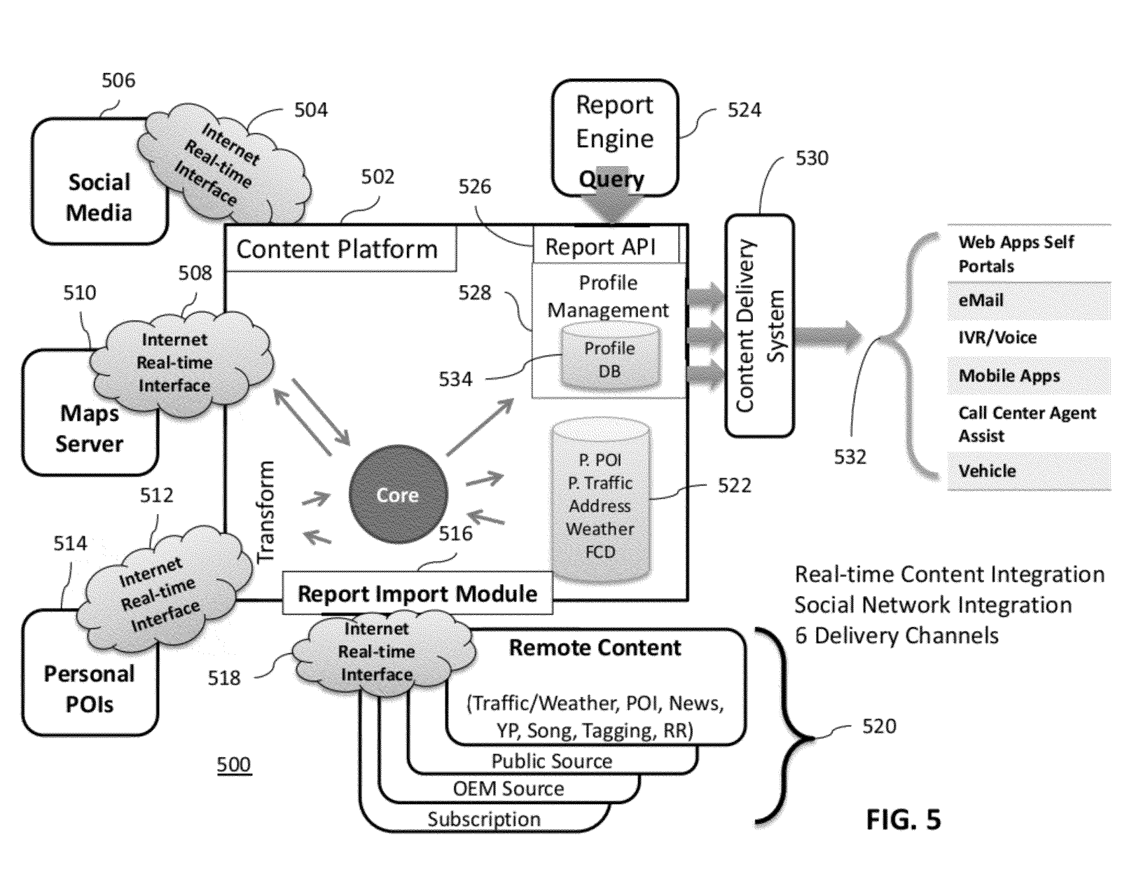

FIG. 5 is an example architecture 500 for implementing a content platform as disclosed herein. Architecture 500 may be implemented in, for example, remote data center 200. Content platform 502 has a report application programming interface (API) module 526, a profile management module 528, a report import module 516, and a plurality of real-time interfaces 504, 508, 512, 518. Content platform 502 receives report queries from report engine 524 at report API 526. Content platform 502 connects to social media server 506, maps server 510, and personal POI server 514, via real-time interfaces 504, 508, and 512, respectively.

Remote import module 516 provides remote content 520 via real-time interface 518. Remote content may include, but is not limited to: traffic; weather; POI; News; yellow pages; song; tagging; and/or RR. The remote content may be from a public source, an OEM source, or provided by subscription.

Profile management module 528 is associated with profile database 534. In conjunction with database 522 and profile database 534, profile management module 528 can provide personalized POI and personalized traffic information. In addition, profile management module 528 can provide address, weather, and FCD information. Profile management module 528 provides content, information, reports, etc. via content delivery system 530 in response to requests initiated via a menu 532. Example categories that may be included in the menu 532 in order to initiate content delivery are web applications self portals, email, IVR/Voice, Mobile Applications, Call center agent assist, and vehicle. Content may be delivered, for example, to telematics unit 103.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive.

1. A method for providing telematics information via a remote data center, comprising:
storing user profile information at the remote data center;
providing a telematics connection between a telematics system of a vehicle and the remote data center;
receiving a request from the telematics system at the remote data center;
interpreting the request at the remote data center;
selecting, at the remote data center, relevant user profile information;
determining, at the remote data center, result information for the request based on the relevant user profile information; and
routing content to the telematics system, the content comprising at least a portion of the result information.

2. The method according to claim 1, which further comprises receiving the user profile information at the remote data center from a web portal.

3. The method according to claim 1, which further comprises:
storing, at the remote data center, pre-configured user profiles containing at least the user profile information; and
accessing the user profiles at the remote data center in response to the received request.

4. The method according to claim 1, wherein the user profile information comprises predefined user preferences.

5. The method according to claim 4, which further comprises utilizing the predefined user preferences by the remote data center in ranking the result information.

6. The method according to claim 4, which further comprises storing the predefined user preferences in a database at the remote data center.

7. The method according to claim 1, wherein the received request is a spoken request from a user at the vehicle.

8. The method according to claim 7, wherein the spoken request comprises a one-phrase command.

9. The method according to claim 8, which further comprises:
recognizing the one-phrase command with a voice recognition system of the remote data center; and
with the remote data center, automatically associating the one-phrase command with one or more predefined user preferences.

10. The method according to claim 9, which further comprises utilizing the one or more predefined user preferences to provide preferred result information.

11. The method according to claim 1, which further comprises keeping track of a user's past successful usage with a tracking system of the remote data center.

12. The method according to claim 11, which further comprises learning and recognizing user preferences using the tracking system of the remote data center.

13. A method for providing telematics information via a telematics system, comprising:
storing predefined user preferences in a data center remote from a vehicle;
establishing a telematics connection between the telematics system of the vehicle and the remote data center;
sending a spoken request for telematics content to the remote data center from the vehicle; and
receiving telematics content from the remote data center in response to the spoken request, the received telematics content being based on the predefined user preferences.

14. The method according to claim 13, wherein the spoken request comprises a one-phrase command.

15. The method according to claim 14, which further comprises:
recognizing the one-phrase command with a voice recognition system of the remote data center; and
with the remote data center, automatically associating the one-phrase command with one or more of the predefined user preferences.

16. A data processing system, comprising:
a data center having a content database operable to store user profile information, result information, and content;
a telecommunications network link operable to provide a telematics connection between a telematics system of a vehicle and the data center;
a voice recognition system operable to:
receive a request from the telematics system;
interpret the request;
locate user profile information in the content database that is relevant to the request;
determine result information for the request based upon the located user profile information; and
route content to the telematics system, the content comprising at least a portion of the result information.

17. The data center according to claim 16, wherein:
the remote data center is operable to communicate with a web portal; and
the remote data center receives the user profile information from the web portal.

18. The data center according to claim 16, wherein:
the user profile information comprises predefined user preferences; and
the content database stores the predefined user preferences.

19. The data center according to claim 16, further comprising a tracking system operable to keep track of past successful usage.

20. The data center according to claim 16, wherein the content database is operable to store and provide marketing information based upon the predefined user preferences.
